(19) United States
(12) Patent Application Publication
(10) Pub. No.: US 2010/0167153 A1
(43) Pub. Date: Jul. 1, 2010

(54) FUEL CELL APPARATUS

(75) Inventors: Jun Yamamoto, Tokyo (JP); Satoshi Mogi, Yamato-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/600,379

(22) PCT Filed: Jul. 29, 2008
(86) PCT No.: PCT/JP2008/063936

§ 371 Date: Nov. 16, 2009

(30) Foreign Application Priority Data
Jul. 31, 2007 (JP) 2007-198476

(51) Int. Cl. H01M 8/04

(52) U.S. Cl. 429/444

(57) ABSTRACT

Provided is a fuel cell apparatus having a gas permeation mechanism for spontaneously controlling the supply amount of oxidizer from a reduced amount to an amount sufficient for normal operation after a reduction process at the time of activation. The fuel cell apparatus includes a control portion for controlling a potential difference between a fuel electrode and an oxidizer electrode to such a value as to reduce an oxide film of a catalyst used in the oxidizer electrode, and a gas permeation mechanism provided in a flow path through which supplied air flows, wherein the gas permeation mechanism includes a member which allows a gas permeation rate to be controlled depending on surrounding environment.

### TECHNICAL FIELD

The present invention relates to a fuel cell apparatus.

### BACKGROUND ART

A polymer electrolyte fuel cell basically includes a polymer electrolyte membrane having proton conductivity and a pair of electrodes disposed on both sides of the polymer electrolyte membrane.

The electrode mainly includes a catalyst layer made of a platinum or platinum group metal catalyst, and a gas diffusion electrode formed on an outer surface of the catalyst layer working for supplying gas and collecting electric power.

A member having the electrodes integrated with the polymer electrolyte membrane is referred to as a membrane electrode assembly (MEA). One of the electrodes is supplied with fuel (hydrogen), and another electrode is supplied with oxidizer (oxygen), so that electric power is generated.

In a fuel electrode that is supplied with fuel, a reaction expressed by the formula (1) below occurs, so that protons and electrons are generated from the hydrogen.

Further, in an oxidizer electrode that is supplied with oxidizer, a reaction expressed by the formula (2) below occurs, so that water is produced from oxygen, protons and electrons.

At this time, the protons move from the fuel electrode to the oxidizer electrode through the polymer electrolyte membrane.

In addition, the electrons move from the fuel electrode to the oxidizer electrode through an external load. In this process, electric power is obtained.

Fuel Electrode: H₂→2H⁺+2e⁻ (1)

Oxidizer Electrode: ½O₂+2H⁺+2e⁻→H₂O (2)

The theoretical voltage of a fuel cell is approximately 1.23 volts, but it is used at approximately 0.7 volts in a normal operation state in many cases.

This drop of the voltage is related to various losses (polarization) inside the cell.

Among the polarization, a reason why the catalyst activity is decreased is known to be that when a potential difference between electrodes of a fuel cell is kept at a high voltage of 0.8 volt or more, an oxide film will be formed on the surface of a platinum catalyst used for an oxidizer electrode.

In order to maintain the characteristics of the fuel cell in a stable state with a high voltage immediately after the start of the operation, it is necessary to remove the oxide film on the surface of the catalyst.

Hitherto, a method of causing a short circuit between electrodes of a fuel cell is known as a method of removing an oxide film on the surface of a catalyst.

In Japanese Patent Application Laid-Open No. 2005-93143, there is described that a short circuit is caused between electrodes when a fuel cell is activated, whereby the voltage is maintained to be approximately 0 volt. As a result, an oxide film is electrically reduced.

In this case, the magnitude of current flowing due to the short circuiting of the fuel cell depends on the supply amount of air. Therefore, the larger the current, the larger the fuel consumption amount.

When it is intended only to reduce the oxide film, it is advantageous to cause the short circuiting in a state where the supply amount of air is as small as possible, thereby reducing the consumption of the fuel.

In addition, Japanese Patent Application Laid-Open No. 2006-228553 discloses a method of causing short circuiting between electrodes at the time of activation of a fuel cell in a state where a fuel electrode is supplied with fuel and an oxidizer electrode is not supplied with oxidizer, thereby removing an oxide film on the surface of a catalyst.

When the voltage of the fuel cell is approximately 0 volt in the state where the oxidizer is insufficient, a reaction expressed by the formula (3) below occurs in the oxidizer electrode besides the reaction expressed by the formula (2).

Oxidizer Electrode: 2H⁺+2e⁻→H₂ (3)

It is considered that according to the formula (3), hydrogen is generated in the oxidizer electrode to bring the oxidizer electrode into a reducing atmosphere, whereby the reduction of the oxide film on the surface of the catalyst proceeds in a larger scale.

In this case, it is necessary to provide a mechanism for controlling the supply amount of the oxidizer from the insufficient amount to an amount sufficient for normal operation after the reduction process.

However, the fuel cell systems of the background art disclosed in Japanese Patent Application Laid-Open No. 2005-93143 and Japanese Patent Application Laid-Open No. 2006-228553 above need a large scale of mechanism for controlling the supply amount of an oxidizer from an insufficient amount to an amount sufficient for normal operation after the reduction process.

In the background art, there has been carried out a method in which in order to perform control such that the supply amount of oxidizer becomes is insufficient in the reduction process, an inert gas such as nitrogen is introduced into oxidizer, or a method in which a ventilation means such as a fan or compressor is stopped to reduce the supply amount of the oxidizer.

Thereafter, there has been carried out a method in which an amount sufficient for normal operation is supplied by switching from nitrogen gas to oxidizer gas or turning on the ventilation means after the reduction process.

Therefore, a large scale of mechanism using an auxiliary machine and its controller has been needed for controlling the amount of oxidizer in the reduction process.

Such a mechanism may cause size increase of the system and an increase in power consumption and is therefore not suitable for a small fuel cell.

### DISCLOSURE OF THE INVENTION

It is, therefore, an object of the present invention in view of the above-mentioned problems to provide a fuel cell apparatus having a gas permeation mechanism for spontaneously controlling the supply amount of oxidizer from a reduced amount to an amount sufficient for normal operation after a reduction process at the time of activation without using a large-scale mechanism such as an auxiliary machine and its controller.

According to the present invention, there is provided a fuel cell apparatus including:

a fuel cell for supplying fuel to a fuel electrode provided on one surface of a polymer electrolyte membrane and supplying air to an oxidizer electrode provided on another surface of the polymer electrolyte membrane through an air hole, thereby generating electric power; and

a control portion for controlling a potential difference between the fuel electrode and the oxidizer electrode to such a value as to reduce an oxide film of a catalyst used in the oxidizer electrode,

in which a gas permeation mechanism is provided in a flow path through which air supplied from the air hole flows, and in which the gas permeation mechanism includes a member which allows a gas permeation rate to be controlled depending on surrounding environment.

Further, the fuel cell apparatus according to the present invention is featured by that the member which allows the gas permeation rate to be controlled is a member which responds to temperature to thereby spontaneously act to make gas permeability higher at high temperature than at low temperature.

According to the present invention, it is possible to realize a fuel cell apparatus having a gas permeation mechanism which can spontaneously control the supply amount of oxidizer from a reduced amount to an amount sufficient for normal operation after a reduction process at the time of activation without using a large-scale mechanism such as an auxiliary machine and its controller.

Further features and aspects of the present invention will become apparent from the following detailed description of exemplary embodiments with reference to the attached drawings.

### BRIEF DESCRIPTION OF THE DRAWINGS

FIG. 1 is a schematic diagram illustrating a structure of a fuel cell apparatus according to an embodiment of the present invention.

FIG. 2 is a diagram for explaining a behavior of a fuel cell when electrode polarities are reversed according to an embodiment of the present invention.

FIG. 3 is a schematic diagram illustrating a structure of a fuel cell apparatus according to Example 1 of the present invention.

FIG. 4 is a schematic diagram illustrating a structure of a fuel cell unit according to Example 1 of the present invention.

FIG. 5 is a schematic diagram illustrating a structure of a fuel cell apparatus according to Example 2 of the present invention.

FIG. 6 is a schematic diagram illustrating a structure of a fuel cell apparatus according to Example 3 of the present invention.

FIG. 7 is a schematic diagram illustrating a structure of a fuel cell apparatus according to Example 4 of the present invention.

### BEST MODE FOR CARRYING OUT THE INVENTION

Embodiments of the present invention are described with reference to the accompanying drawings.

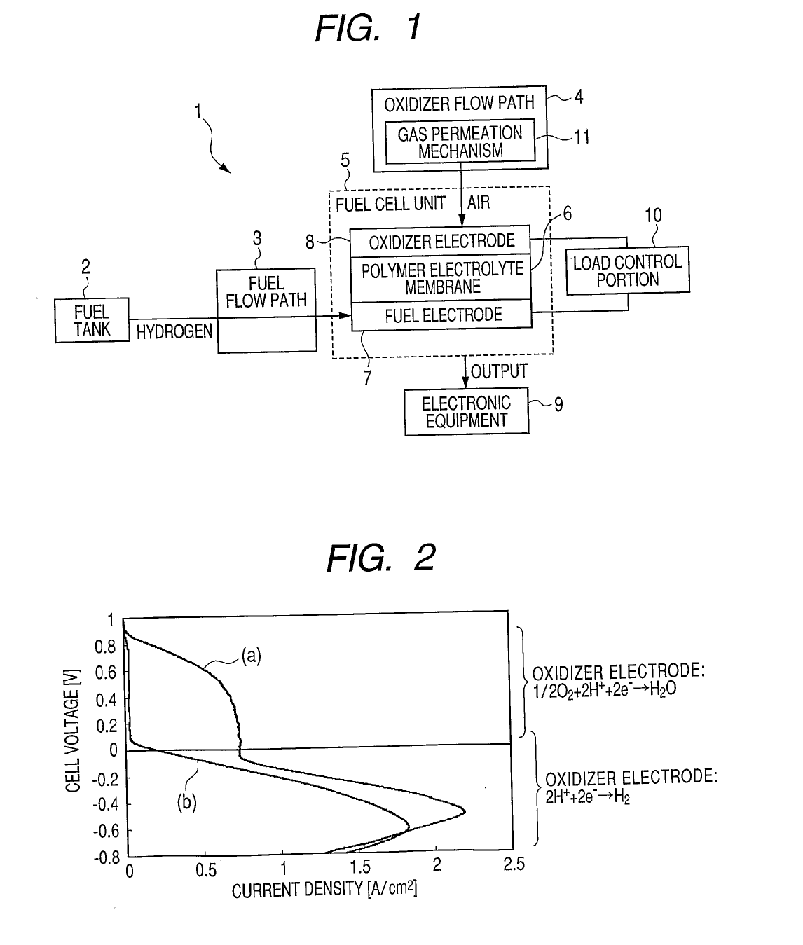

FIG. 1 is a schematic diagram illustrating a structure of a fuel cell apparatus according to the present embodiment.

In FIG. 1, a fuel cell apparatus 1 includes a fuel tank 2, a fuel flow path 3, an oxidizer flow path 4, a fuel cell unit 5, a polymer electrolyte membrane 6, a fuel electrode 7, an oxidizer electrode 8, an electronic equipment 9, a load control portion 10, and a gas permeation mechanism 11.

In this embodiment, the fuel cell apparatus 1 includes the fuel cell unit 5 with a membrane electrode assembly having a structure in which the fuel electrode 7 and the oxidizer electrode 8 are disposed on both sides of the polymer electrolyte membrane 6, or a fuel cell stack that is a plurality of stacked fuel cell units.

In addition, the fuel cell apparatus 1 includes the fuel flow path 3 for supplying fuel to the fuel electrode 7 and the oxidizer flow path 4 for supplying oxidizer to the oxidizer electrode 8.

The oxidizer flow path 4 is provided with the gas permeation mechanism 11 for adjusting the supply amount of the oxidizer.

In addition, the fuel cell apparatus 1 includes the load control portion 10 that is connected to the fuel electrode 7 and the oxidizer electrode 8.

In the fuel cell unit 5 of the present embodiment, there can be used pure hydrogen, methanol or the like as the fuel. However, it is preferred to use hydrogen as the fuel, which can produce high power and has little polarization in the fuel electrode.

The fuel electrode 7 is supplied with hydrogen fuel through the fuel flow path from the fuel tank 2, for example. Any type of the fuel tank 2 can be used as long as it can supply hydrogen fuel to the fuel cell.

It is preferred to use one that stores highly compressed hydrogen or hydrogen absorbed by a hydrogen storage alloy material.

Further, it is also possible to adopt a method of generating hydrogen through a reaction between water and metal powder such as of Al, Mg, or Fe, or a method of obtaining hydrogen from a metal borohydride of Na, K or the like.

In addition, it is also possible to adopt another method of storing liquid fuel such as methanol or ethanol in the fuel tank 2 and obtaining hydrogen gas from the liquid fuel by using a reformer so that the hydrogen gas is supplied to the fuel cell.

The fuel flow path 3 and the fuel electrode 7 have a structure for preventing leakage of the fuel supplied from the fuel tank 2 to the outside of the system, which are seal members disposed at connecting parts between the components as well as at a periphery of the fuel electrode.

The oxidizer electrode 8 is supplied with air that is taken in through an air hole and is diffused naturally. In addition, it is possible to supply air by using an auxiliary machine such as a fan.

The gas permeation mechanism 11 is disposed in a flow path through which air supplied from the air hole flows, so as to control the gas permeation rate depending on the surrounding environment.

Such a gas permeation mechanism 11 can be formed of a member which responds to temperature to thereby make higher the gas permeability at high temperature than at low temperature.

In addition, when such a gas permeation mechanism is constituted, a bimetal or a shape memory alloy can be used as the material for the structure of the gas permeation mechanism.

With such constitution, the shape of the bimetal or the shape memory alloy will change as the temperature of the fuel cell apparatus rises, so that the gas permeation mechanism increases the gas permeability, whereby the supply amount of the oxidizer can be increased.

It is desirable to adopt a structure such that at a temperature at the time of activation of the fuel cell, the air hole is closed so that the supply amount of oxidizer is decreased to an amount insufficient for normal operation of the fuel cell, while at a predetermined temperature less than the temperature during normal operation of the fuel cell, the air hole is opened so that the supply amount of the oxidizer is increased to an amount sufficient for normal operation of the fuel cell.

In addition, the gas permeation mechanism 11 can also be formed of a member which responds to moisture (or humidity) or water to thereby make higher the gas permeability in a wet state than in a dry state.

When such a gas permeation mechanism is constituted, a water absorbing and swelling material can be used as the material constituting the gas permeation mechanism.

More specifically, there can be included, for example, a structure in which a film which is swelled with moisture and a film which is not swelled with moisture are stacked on each other and applied to an air hole, and displacement of the stacked film in accordance with the state of wetness is utilized.

The above structure is preferably such that the displacement of the film acts so as to increase the gas permeation rate when wetted.

In addition, it is possible to use woven material made of fibers which extend by moisture absorption and shrink by drying.

Further, as the water for wetting such materials, water produced by the power generation of the fuel cell.

It is desirable to adopt a structure such that at the time of activation of the fuel cell, the air hole is closed to cut off the air supply, while when supplied with water produced by the power generation of the fuel cell, the air hole is quickly opened so that the supply amount of the oxidizer is increased.

The fuel cell unit 5 is connected to the load control portion 10, in addition to the electronic equipment 9 that is an external load to which the output of the power generation is supplied.

The load control portion 10 has a function of controlling a potential difference between the fuel electrode 7 and the oxidizer electrode 8.

Incidentally, the term “potential difference” herein employed refers to a difference between the potential of the oxidizer electrode and the potential of the fuel electrode, which means a cell voltage. In addition, the term “potential” herein employed refers to a relative value with the electrode potential of a standard hydrogen electrode being defined as 0 volt.

The load control portion 10 controls the potential difference between the fuel electrode 7 and the oxidizer electrode 8 to be a value at which an oxide film of a catalyst used in the oxidizer electrode is reduced.

Here, the redox reaction of platinum is a reaction caused by Pt and PtO as shown in the formula (4) below and occurs at a potential of approximately 0.8 volts.

PtO+2H⁺+2e⁻ [symbol] Pt +H₂O (4)

Therefore, in a case where platinum is used as the catalyst, the reduction is performed by controlling the potential of the oxidizer electrode to be 0.8 volt or less. The lower the potential is with respect to the redox potential, the more advantageously the reduction proceeds. Therefore, it is actually preferred to control the potential to be 0.6 volt or less.

In general, in the case of a fuel cell using hydrogen as fuel, the overvoltage in the reaction of the formula (1) of taking protons from hydrogen at the fuel electrode is sufficiently smaller than the overvoltage in the reaction of the formula (2) at the oxidizer electrode, and the potential of the fuel electrode is approximately 0 volt within the range of normal power generation. Therefore, it can be estimated that the cell voltage and the potential of the oxidizer electrode are close to each other.

Accordingly, for reducing platinum, it is preferred to control the cell voltage to be 0.6 volt or less.

In addition, when the cell voltage is controlled to be approximately 0 volt, the potential of the oxidizer electrode also becomes approximately 0 volt, which is more advantageous for the reduction and preferable.

In this case, for the load control portion 10, there can be adopted a simple structure such as causing short circuiting between the fuel electrode 7 and the oxidizer electrode 8.

Elemental platinum is stable in the values described above, which fact can be confirmed by a potential-pH diagram. It is considered that by controlling the cell voltage to be approximately 0 volt, an oxide film on the surface of the platinum is removed to improve the activity.

Further, it is known that in addition to platinum, elemental metals such as gold, palladium, rhodium, ruthenium, iridium, and osmium show the redox reaction of the formula (2). According to the potential-pH diagram, most of these elemental metals are also stable at approximately 0 volt. Therefore, it is considered that also for these metal materials, it is effective for improving the activity to perform the process of maintaining the cell voltage at approximately 0 volt.

Moreover, in the case of a fuel cell using liquid fuel such as methanol, the overvoltage of the reaction of taking protons from fuel on a fuel electrode side is higher than that in the case of using hydrogen.

Therefore, for the reduction of platinum, it is preferred to control the cell voltage to be approximately 0.4 volts or less, more preferably approximately 0 volt.

In addition, the load control portion 10 may be structured such that in a state where fuel is supplied to the fuel electrode, the potential difference between the fuel electrode 7 and the oxidizer electrode 8 is controllable to such a value as to cause the hydrogen generation reaction of the formula (3) at the oxidizer electrode.

The hydrogen generation reaction at the oxidizer electrode is caused by controlling the voltage of the fuel cell to be approximately 0 volt or less.

In this case, the potential of the oxidizer electrode is controlled to be even lower than 0 volt, which is advantageous for the reduction. In addition, it is considered that because the generation of hydrogen brings the oxidizer electrode into a reducing atmosphere, the reduction of the oxide film on the surface of the catalyst proceeds in a larger scale.

FIG. 2 is a graphical representation illustrating a current-voltage characteristic of a fuel cell, which shows current behavior when the cell voltage is swept to the negative voltage side. The fuel cell used has a structure for taking in air by natural diffusion. The curve (a) of FIG. 2 shows the behavior in the case where the supply amount of air is sufficient for normal operation, and the curve (b) shows the behavior in the case where the supply amount of air is reduced by, for example, decreasing the area for taking in air. A negative value of the cell voltage indicates that the relationship between the potential of the oxidizer electrode and the potential of the fuel electrode is inverted. This state is called polarity reversal.

In the mode of the curve (a), at a cell voltage of 0 volt or more, at the oxidizer electrode, the redox reaction of the formula (2) occurs, so that the so-called power generation reaction of the fuel cell is performed. When the cell voltage becomes a negative value below 0 volt, that is, when the polarity reversal occurs, the hydrogen generation reaction of the formula (3) occurs at the oxidizer electrode. At this time, the reason for the increase of the current value shown in FIG. 2 is that the amount of protons supplied to the oxidizer electrode is larger than the amount of air supplied to the oxidizer electrode. When the cell voltage is made larger in terms of a negative value, a peak of current density appears at approximately −0.5 volt. This is considered to indicate a maximum value of the supply amount of protons. In such a process in which the supply of protons is a rate-determining factor, the overvoltage of the fuel electrode becomes large, so that the potential of the fuel electrode becomes high. When a process for maintaining the cell voltage at a voltage less than −0.6 volt is performed, the potential of the fuel electrode increases such that degradation of the material (such as corrosion of carbon) or electrolytic reaction of water is caused, which is not preferable.

In the mode of the curve (b), the supply amount of air is reduced, so that the current which flows in the power generation reaction of the fuel cell represented by the formula (2) is small. However, because the hydrogen generation reaction of the formula (3) due to the polarity reversal depends on the supply amount of protons, a large current value is shown as with the mode of the curve (a).

In addition, in the mode of the curve (b), there is recognized an increase in the current value due to the hydrogen generation reaction in the range which is less than about 0.1 volt and extends over the negative voltage side. This is considered to be attributable to a voltage distribution in the cell plane or a difference in hydrogen concentration, and it can be seen therefrom that the hydrogen generation reaction occurs even at a cell voltage near 0 volt in the state where the supply amount of air is reduced.

In addition, when a voltage with an opposite polarity is applied between the electrodes of the fuel cell in the presence of air, the fuel cell reaction represented by the formula (2) and the hydrogen generation reaction represented by the formula (3) occur at the same time, so that the heat generation amount further increases, which is advantageous for the gas permeation mechanism that increases the gas permeation amount depending on temperature.

As described above, in order to generate hydrogen at the oxidizer electrode, it suffices to apply a voltage with an opposite polarity between the electrodes of the fuel cell. The desirable structure is such that the load control portion 10 applies a voltage of 0 to 0.6 volt with an opposite polarity between the electrodes of the fuel cell.

Moreover, when the supply amount of air is reduced to a small value, the generation of hydrogen can also be accelerated by causing short circuiting between the electrodes.

As a structure for performing the process described above, it is possible to adopt a mechanism for controlling the voltage of the fuel cell by using an external power supply, or a switch as means for causing short circuiting between the electrodes.

The operation of a fuel cell apparatus according to the present invention is described below.

Here, the load control portion 10 has a structure for causing short circuiting between the electrodes of the fuel cell, and the gas permeation mechanism 11 has a structure for increasing the gas permeability by responding to temperature.

At the time of activation of the fuel cell, because the heat accompanying power generation is not generated yet, the temperature of the entire apparatus is low.

Therefore, the gas permeation mechanism 11 reduces the gas permeation rate to a small value when the power generation is started. In this state, when the load control portion 10 causes short circuiting between the electrodes of the fuel cell so as to perform the reduction process after supplying the fuel, heat is generated accompanying the power generation so that the temperature of the entire apparatus rises.

Because the supply amount of air is reduced, the current which flows at the time of short circuiting is small. However, by lowering the voltage of the fuel cell to near 0 volt, the power generation efficiency is decreased and the generated heat increases.

Therefore, even in the state where the supply amount of air is reduced by the gas permeation mechanism 11, the entire apparatus can sufficiently be warmed up. Thereafter, the gas permeation mechanism 11 increases the gas permeation amount by responding to the temperature rise and finally becomes capable of supplying air in an amount necessary for normal operation.

Further, in the course of increasing the gas permeation rate, the load control portion 10 stops the reduction process, whereby the operation is switched to normal operation.

The gas permeation mechanism 11 may have a heat transfer mechanism for transfer the heat generated by the fuel cell more securely and more quickly.

According to the structure described above, it is possible to spontaneously control the supply amount of oxidizer from a reduced amount to an amount sufficient for normal operation after a reduction process at the time of activation.

Next, the operation of a fuel cell apparatus according to the present invention is described in which the gas permeation mechanism 11 has a structure for increasing the gas permeability by responding to moisture (humidity) or water.

At the time of activation of the fuel cell, because the water accompanying power generation is not generated yet, the fuel cell is in a more dry state than at the time of normal operation.

Therefore, the gas permeation mechanism 11 reduces the gas permeation rate to a small value when the power generation is started. In this state, when the load control portion 10 causes short circuiting between the electrodes of the fuel cell so as to perform the reduction process after supplying the fuel, water is generated accompanying the power generation.

In this case, because the supply amount of air is reduced to a small value, the current which flows at the time of the short circuiting is small, so that the amount of generated water is limited to a small value.

However, because the gas permeation rate is small, the evaporation of the generated water is suppressed to a small rate, so that the fuel cell and the gas permeation mechanism can be effectively wetted even with a small amount of water.

Of course, in order to complete the reduction process quickly, the gas permeation rate at the time of activation may be a considerable value as long as it is smaller than the gas permeation rate at the time of normal operation.

Further, in the course of increasing the gas permeation rate, the load control portion 10 stops the reduction process, whereby the operation is switched to normal operation.

The gas permeation mechanism 11 may have provided between it and the fuel cell a water supply mechanism for supplying water generated by the fuel cell to the gas permeation mechanism more securely and more quickly.

The term “water supply mechanism” herein employed refers to a mechanism which uses a fibrous member or a member formed of urethane foam or polyacrylamide and transports water to the gas permeation mechanism through a capillary action.

According to the structure described above, it is possible to spontaneously control the supply amount of oxidizer from a reduced amount to an amount sufficient for normal operation after a reduction process at the time of activation.

In addition, when the load control portion 10 performs the operation of applying a voltage having an opposite polarity between the electrodes of the fuel cell, there can be adopted a structure such that a combustion catalyst is disposed close to the gas permeation mechanism 11.

In the reduction process, when the load control portion 10 applies a voltage having an opposite polarity between the electrodes of the fuel cell to generate hydrogen at the oxidizer electrode, the hydrogen generated at the oxidizer electrode and air which flows in through an air hole from atmosphere cause catalyst combustion on the combustion catalyst.

As a result of this catalyst combustion reaction, heat and water are generated. The gas permeation mechanism can be so configured as to respond to the heat or the water to thereby increase the gas permeability.

The catalyst combustion generates much more heat compared with the normal fuel cell reaction, thereby increasing the temperature environment surrounding the gas permeation mechanism quickly, which is advantageous for the gas permeation mechanism which increases the gas permeation rater by responding to temperature.

In addition, because the gas permeation rate is reduced, even when the amount of water generated by the fuel cell reaction at the time of the reduction process is small, water can be produced from hydrogen generated by utilizing the catalyst combustion, which is also advantageous for the gas permeation mechanism that increases the gas permeation amount by responding to moisture.

According to the structure described above, it is possible to spontaneously control the supply amount of oxidizer from a reduced amount to an amount sufficient for normal operation after a reduction process at the time of activation.

### EXAMPLES

Hereinafter, examples of the present invention are described.

### Example 1

In Example 1, a fuel cell apparatus having an open-air fuel cell unit is described in which hydrogen is supplied as fuel and air is taken in as oxidizer through natural diffusion.

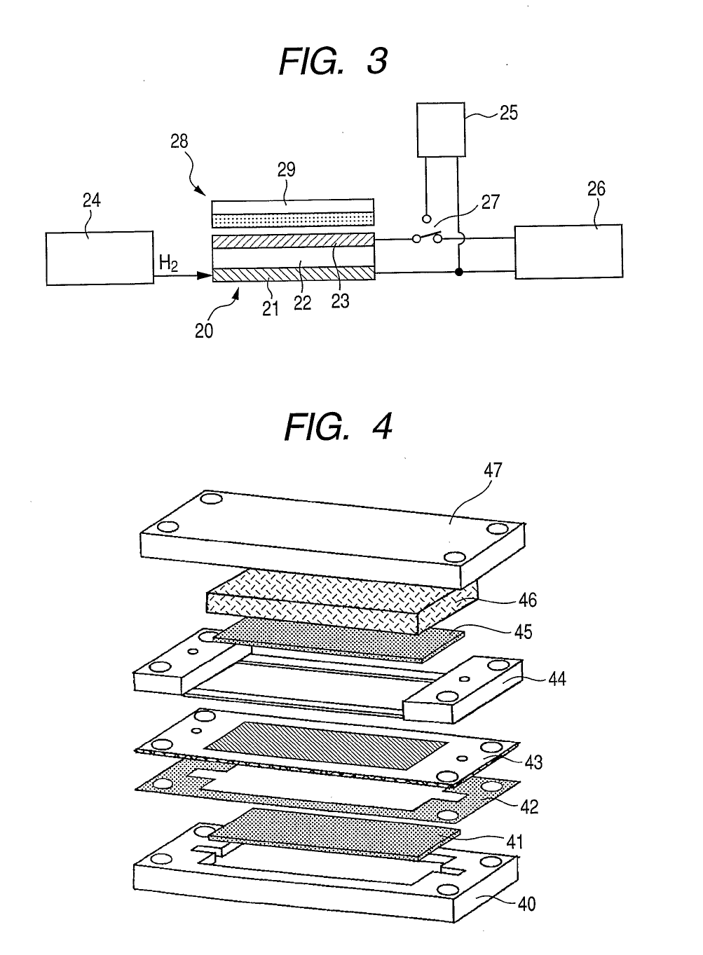

FIG. 3 is a schematic diagram illustrating the structure of the fuel cell apparatus according to this example, and FIG. 4 is a schematic diagram illustrating the structure of the fuel cell unit according this example.

In FIG. 3, a fuel cell unit 20 includes a fuel electrode 21, a polymer electrolyte membrane 22, an oxidizer electrode 23, a fuel tank 24, a short circuit 25, an external load 26 such as electronic equipment, a switch 27, a gas permeation mechanism 28, and a shape memory alloy member 29.

In FIG. 4, the fuel cell unit 20 includes a membrane electrode assembly 43, carbon clothes 41, 45, current collecting plates 40, 47, a seal member 42, a metal foam 46, a support member 44.

The fuel cell unit 20 of this example has a structure in which the membrane electrode assembly 43 is sandwiched between the fuel electrode side members including the current collecting plate (fuel electrode) 40, the carbon cloth 41 and the seal member 42, and the oxidizer electrode side members including the carbon cloth 45, the metal foam 46, the support member 44 and the current collecting plate (oxidizer electrode) 47.

Here, the carbon clothes 41, 45 are gas diffusing layers, and the metal foam 46 is a flow path forming member for taking in air from a side surface of the fuel cell unit.

In addition, the support member 44 faces the seal member 42 via the membrane electrode assembly 43 and uniformly applies a clamping pressure to the seal member so as to secure sealing of the fuel electrode.

In addition, the current collecting plate 40, the seal member 42, the membrane electrode assembly 43, the support member 44 and the current collecting plate 47 each have bolt holes. Those members are stacked while being aligned and clamped by using bolts in a state where the current collecting plates 40, 47 are insulated from each other with an insulating member (not shown).

The gas permeation mechanism 28 is disposed so as to be applied to both side surfaces exposed to atmosphere of the metal foam 46.

In addition, the gas permeation mechanism 28 has a structure of opening its air holes when the shape memory alloy member 29 responds to temperature.

The gas permeation mechanism having such a structure may have a structure similar to a louver used in a house, for example.

Such a louver includes a shape memory alloy that contracts depending on temperature and the air holes are completely closed at a temperature less than a predetermined temperature and are completely opened at the predetermined temperature or more due to the shape change of the shape memory alloy.

In addition, the gas permeation mechanism may have a structure in which materials having different coefficients of thermal expansion are laminated to each other like a bimetal, which warps due to a difference in coefficient of thermal expansion to thereby open the air holes.

Such a material that is deformed depending on temperature may have an operating temperature set arbitrarily within a wide range depending on the kind of the material.

Usually, the fuel cell has a temperature higher by about 20° C. to 40° C. than the ambient air temperature due to the electric power generation. Therefore, it is desirable to select a shape memory alloy member which closes air holes at ambient air temperature and opens the air holes at an arbitrary temperature higher than ambient air temperature and lower than the temperature of the fuel cell in normal operation.

In the fuel cell apparatus having the structure described above, at the time of activation, in order to reduce an oxide film on the surface of a catalyst, the switch 27 is operated to connect the electrodes of the fuel cell to the short circuit 25.

At this time, because the supply amount of air is reduced by the gas permeation mechanism 28, the current flowing at the time of the short circuiting is suppressed so that the consumption of the fuel during the reduction process can be reduced.

In the reduction process, the temperature of the fuel cell increases gradually due to the power generation, and when a predetermined temperature is reached, the shape memory alloy member 29 operates to open air holes so that air sufficient for normal operation can be supplied.

In this process, the switch 27 performs switching from the connection of the electrodes of the fuel cell to the short circuit 25 to the connection to the external load 26, so that the normal operation is started.

According to the structure described above, it is possible to spontaneously control the supply amount of oxidizer from a reduced amount to an amount sufficient for normal operation after a reduction process at the time of activation.

### Example 2

In Example 2, there is described a fuel cell apparatus having another structure than that of Example 1 having an open-air fuel cell unit in which hydrogen is used as fuel and air as oxidizer is taken in by natural diffusion.

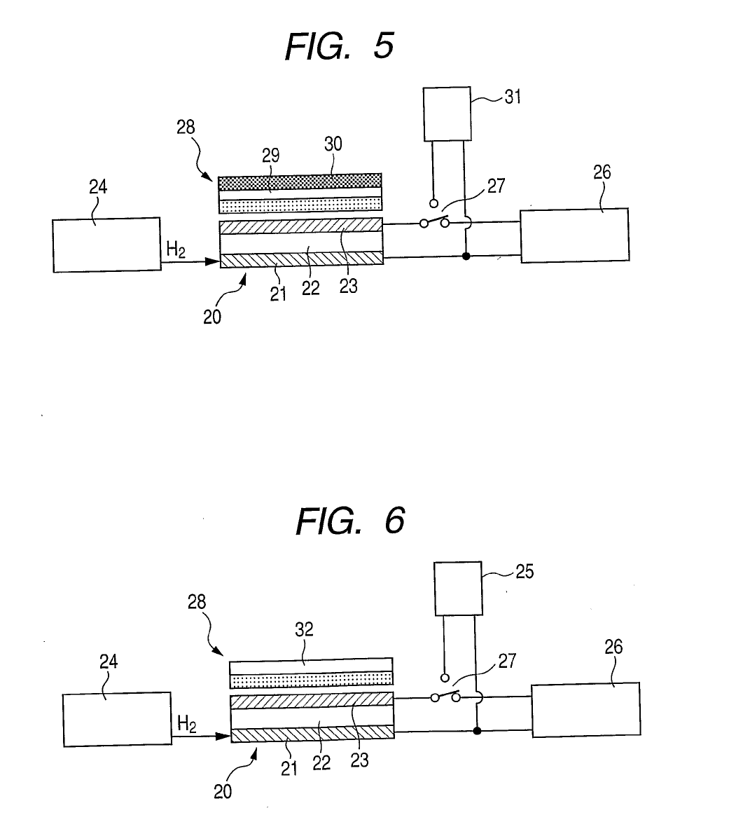

FIG. 5 is a schematic diagram illustrating the structure of the fuel cell apparatus according to this example.

The structure of the fuel cell according to this example is basically the same as the structure of the fuel cell according to Example 1 illustrated in FIGS. 3 and 4, so that the description of the common elements is omitted.

In FIG. 5, the fuel cell unit 20 includes a combustion catalyst 30 and an external power supply 31.

In this example, the combustion catalyst 30 is disposed in the vicinity of the shape memory alloy member 29 of the gas permeation mechanism 28.

In addition, the external power supply 31, instead of the short circuit 25, is disposed for applying a voltage having an opposite polarity to the electrodes of the fuel cell.

The combustion catalyst 30 can be any material that can cause a combustion reaction between hydrogen and oxygen, and is desirably a platinum catalyst.

In addition, the voltage applied by the external power supply 31 is desirably between 0 volt and 0.6 volt. In addition, it is also possible to adopt a mechanism of causing short circuiting instead of the external power supply.

The combustion catalyst 30 was disposed to the gas permeation mechanism 28 by applying a catalyst slurry thereto.

The slurry was prepared by using platinum black powder as the catalyst and adding a Nafion alcohol solution thereto, followed by mixing.

When a voltage of 0.3 volt having an opposite polarity was applied to the electrodes of the fuel cell unit by the external power supply 31, hydrogen was generated at the oxidizer electrode to reduce the oxide film on the surface of the catalyst.

In addition, the generated hydrogen reached the combustion catalyst 30 of the gas permeation mechanism 28 and caused a combustion reaction with oxygen from the outside air on the combustion catalyst.

At this time, when the temperature of the atmosphere side surface of the gas permeation mechanism 28 was measured by use of a radiation thermometer, which indicates a temperature more than 100° C.

Since the temperature rapidly rises from the initial stage of the reduction process, the shape memory alloy member 29 can operate more quickly.

In addition, when the ambient air temperature is low such as in winter, it may take a long period of time to warm up the fuel cell only by the heat accompanying the driving of the fuel cell.

However, in this example, since high heat due to the catalyst combustion reaction can be utilized, it is possible to realize a temperature environment necessary for the operation of the shape memory alloy member regardless of the ambient air temperature.

Thus, it is possible to spontaneously control the supply amount of oxidizer from a reduced amount to an amount sufficient for normal operation after a reduction process at the time of activation.

### Example 3

In Example 3, there is described a fuel cell apparatus having another structure than that of Example 1 having an open-air fuel cell unit in which hydrogen is used as fuel and air as oxidizer is taken in by natural diffusion.

FIG. 6 is a schematic diagram illustrating a structure of the fuel cell apparatus according to this example.

The structure of the fuel cell according to this example is the same as the structure of the fuel cell according to Example 1 illustrated in FIGS. 3 and 4 with the exception that the gas permeation mechanism 28 does not have the shape memory alloy member 29 but has a self-moisture-conditioning function member 32.

The gas permeation mechanism 28 is configured such that the self-moisture-conditioning function member 32 responds to moisture or water to change its shape by extension or shrinkage opens, thereby opening air holes.

As a material that can be used for the self-moisture-conditioning function member 32, there is included, for example, a self-regulatory functional fiber “MRT fiber” (trade name) manufactured by TEIJIN FIBERS LIMITED.

Such a fiber has a reversible extension/shrinkage property, and extends by water absorption and shrinks by water release (drying), thus reducing the gas permeability when dried and increasing the gas permeability when wetted.

The self-moisture-conditioning function member 32 is disposed in an oxidizer flow path. However, in order to more sensitively respond to the moisture in the oxidizer flow path, it is preferred that the self-moisture-conditioning function member 32 is disposed at a position where water vapor generated by the fuel cell is liable to cause dew condensation.

Alternatively, there may be provided a water supply mechanism for guiding water generated by the fuel cell to the self-moisture-conditioning function member 32.

The term “water supply mechanism” herein employed refers to a mechanism which uses a fibrous member or a member formed of urethane foam or polyacrylamide and transports water to the gas permeation mechanism through a capillary action. With these structures, the gas permeation rate can be controlled.

In the fuel cell apparatus having the structure described above, at the time of activation, in order to reduce an oxide film on the surface of a catalyst, the switch 27 is operated to connect the electrodes of the fuel cell to the short circuit 25.

At this time, because the supply amount of air is reduced by the gas permeation mechanism 28, the current flowing at the time of the short circuiting is suppressed so that the consumption of the fuel during the reduction process can be reduced.

In the reduction process, the fuel cell generates water by the power generation, and absorption of the water allows the self-moisture-conditioning function member 32 to operate to open the air holes so that air sufficient for normal operation can be supplied.

In this process, the switch 27 performs switching from the connection of the electrodes of the fuel cell to the short circuit 25 to the connection to the external load 26, so that the normal operation is started.

In this case, because the supply amount of air is reduced to a small value, the current which flows at the time of the short circuiting is small, so that the amount of generated water is limited to a small value.

However, because the gas permeation rate is small, the evaporation of the generated water is suppressed to a small rate, so that the fuel cell and the gas permeation mechanism can be effectively wetted even with a small amount of water.

According to the structure of the present example, it is possible to spontaneously control the supply amount of oxidizer from a reduced amount to an amount sufficient for normal operation after a reduction process at the time of activation.

### Example 4

In Example 4, there is described a fuel cell apparatus having another structure than that of Example 1 having an open-air fuel cell unit in which hydrogen is used as fuel and air as oxidizer is taken in by natural diffusion.

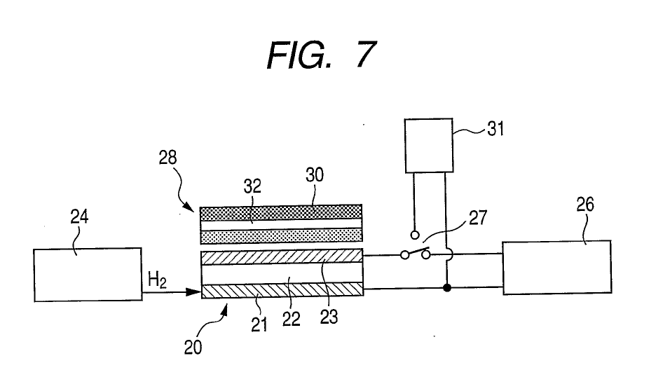

FIG. 7 is a schematic diagram illustrating a structure of the fuel cell apparatus according to this example.

The structure of the fuel cell according to this example is the same as the structure of the fuel according to Example 3 illustrated in FIG. 6 with the exception that a combustion catalyst 30 is disposed in the vicinity of the self-moisture-conditioning function member 32 of the gas permeation mechanism 28, and that an external power supply 31 is disposed for applying a voltages having an opposite polarity to the electrodes of the fuel cell instead of the short circuit 25 of FIG. 6.

When a voltage of 0.3 volt having an opposite polarity was applied to the electrodes of the fuel cell unit by the external power supply 31, hydrogen was generated at the oxidizer electrode to reduce the oxide film on the surface of the catalyst.

In addition, the generated hydrogen reached the combustion catalyst 30 of the gas permeation mechanism 28 and caused a combustion reaction with oxygen from the outside air on the combustion catalyst.

The water generated at this time is absorbed by the self-moisture-conditioning function member 32, whereby the gas permeation mechanism 28 can increase the gas permeation rate.

In addition, when the catalyst activity is too high, the water generated by the catalyst combustion may be evaporated to the outside due to high temperature of the surroundings. In such a case, the surface area of the combustion catalyst may be reduced to lower the activity.

With the structure described above, because the gas permeation rate is reduced, even when the amount of water generated by the fuel cell reaction in the reduction process is small, water can be produced from hydrogen generated by utilizing the catalyst combustion, which is also advantageous for the gas permeation mechanism that increases the gas permeation rate by responding to moisture.

According to the structure of the present example, it is possible to spontaneously control the supply amount of oxidizer from a reduced amount to an amount sufficient for normal operation after a reduction process at the time of activation.

This application claims the benefit of Japanese Patent Application No. 2007-198476, filed Jul. 31, 2007, which is hereby incorporated by reference herein in its entirety.

1. A fuel cell apparatus, comprising:
a fuel cell for generating electric power by supplying fuel to a fuel electrode provided on one surface of a polymer electrolyte membrane and by supplying air to an oxidizer electrode provided on another surface of the polymer electrolyte membrane through an air hole; and
a control portion for controlling a potential difference between the fuel electrode and the oxidizer electrode to such a value as to reduce an oxide film of a catalyst used in the oxidizer electrode,
wherein a gas permeation mechanism is provided in a flow path through which air supplied from the air hole flows, and
wherein the gas permeation mechanism comprises a member which allows a gas permeation rate to be controlled depending on surrounding environment.

2. The fuel cell apparatus according to claim 1, wherein the member which allows the gas permeation rate to be controlled is a member which responds to temperature to thereby spontaneously act to make gas permeability greater at a higher temperature than at a lower temperature.

3. The fuel cell apparatus according to claim 2, wherein the member which makes the gas permeability greater is formed of a bimetal or a shape memory alloy, a shape of which changes so as to increase the gas permeability by corresponding to a temperature rise.

4. The fuel cell apparatus according to claim 1, wherein the member which allows the gas permeation rate to be controlled is a member which responds to moisture or water to thereby spontaneously act to make gas permeability greater in a wetter state than in a drier state.

5. The fuel cell apparatus according to claim 4, wherein the member which makes the gas permeability greater is formed of a water absorbing and swelling material, a shape of which changes so as to increase the gas permeability by corresponding to wetting.

6. The fuel cell apparatus according to claim 1, wherein the control portion is structured such that in a state where the fuel is supplied to the fuel electrode, the potential difference between the fuel electrode and the oxidizer electrode is controllable to such a value as to cause a hydrogen generation reaction at the oxidizer electrode.

7. The fuel cell apparatus according to claim 1, wherein a combustion catalyst is disposed close to the gas permeation mechanism such that gas permeability is increasable by responding to heat generated by a reaction between oxygen and hydrogen at the combustion catalyst.

8. The fuel cell apparatus according to claim 1, wherein a combustion catalyst is disposed close to the gas permeation mechanism such that gas permeability is increasable by responding to water generated by a reaction between oxygen and hydrogen at the combustion catalyst.

9. The fuel cell apparatus according to claim 1, wherein a water supply mechanism of supplying water generated by the fuel cell is provided to the gas permeation mechanism.

10. The fuel cell apparatus according to claim 1, which is an open-air fuel cell in which air is taken as an oxidizer into the oxidizer electrode by natural diffusion.
